(19) United States
(12) Patent Application Publication
(10) Pub. No.: US 2026/0038266 A1
(43) Pub. Date: Feb. 5, 2026

(54) Determining Keyframes Of A Video

(71) Applicant: Coactive Systems Inc., San Jose, CA (US)

(72) Inventors: Stephen Oscar Mussmann, Fremont, CA (US); Kavya Tumkur, San Francisco, CA (US)

(73) Assignee: Coactive Systems Inc., San Jose, CA (US)

(21) Appl. No.: 19/200,821

(22) Filed: May 7, 2025

Related U.S. Application Data
(60) Provisional application No. 63/677,490, filed on Jul. 31, 2024.

(51) Int. Cl. G06V 20/40; G06V 10/82; G06V 10/86; G06V 10/96

(52) U.S. Cl. CPC G06V 20/47; G06V 10/82; G06V 10/86; G06V 10/96; G06V 20/49

(57) ABSTRACT

A computer obtains, from a data repository, a set of frames of a video. The computer generates, by a neural engine, a data structure of representation costs for the set of frames. The computer determines, by a dynamic programming engine and based on the data structure and at least one stored rule, a set of keyframes for the video, wherein each keyframe represents a time contiguous subset of the set of frames. The computer provides an output of the set of keyframes.

### PRIORITY CLAIM

This application claims the benefit of U.S. Provisional Patent Application No. 63/677,490, filed on Jul. 31, 2024, titled “DETERMINING KEYFRAMES OF A VIDEO,” the entire disclosure of which is incorporated herein by reference.

### TECHNICAL FIELD

Embodiments pertain to image processing or video processing. Some embodiments relate to determining keyframes of a video.

### BACKGROUND

Videos may be stored in data repositories or online video storage systems. In some cases, it may be desirable to generate a visual summary of a video, for example, to allow a user to determine if they wish to watch the full video. Techniques for generating the visual summary may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates a convolutional neural network, in accordance with some embodiments.

FIG. 5 is a block diagram of a computing machine, in accordance with some embodiments.

FIG. 6 is a block diagram of a system for determining keyframes of a video, in accordance with some embodiments.

FIG. 7 illustrates an example of representation costs and keyframes for a set of frames.

FIG. 8 is a flowchart of an example technique for determining keyframes of a video, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some implementations of the technology disclosed herein relate to a keyframe engine (e.g., implemented in software and/or hardware) for determining keyframes of a video by subsampling the video into images. The keyframe engine determines the lowest number of frames needed to represent a video without missing any important parts. One goal is to select a few keyframes from a sequence of frames that are representative of the video's content. The keyframe engine uses a neural engine (e.g., an artificial neural network) to compute the representation cost between pairs of frames in the video (e.g., each pair of frames or pairs of frames that are less than a threshold time (e.g., 30 seconds) or a threshold number of frames (e.g., 720 frames) apart). The representation cost is a measure of how well one frame represents another. For example, a representation cost of 0 may indicate that the frames are identical, and a representation cost of 1 may represent that the frames are very different. The keyframe engine then selects keyframes by minimizing a mathematical function (e.g., a sum or a product) of the total representation cost and the number of keyframes. The engine may accomplish this using dynamic programming, which breaks the problem down into smaller subproblems.

The keyframe engine subsamples a video into a set of images by selecting a few keyframes from a sequence of frames of the video that are representative of the video's content. One goal of the keyframe engine is to avoid missing any important parts (e.g., that a person viewing the video would consider important). The keyframe engine accomplishes this by minimizing the mathematical function of the total representation cost and the number of keyframes. In some implementations, the total representation cost is the sum of the representation costs for representing each frame.

The representation cost is a measure of how well one frame represents another. The neural engine is used to compute this representation cost between two images or frames. Frames that are very similar and show the same thing would have a low representation cost, while frames that are very different would have a high representation cost.

The keyframe engine uses dynamic programming to efficiently find the optimal set of keyframes. Dynamic programming breaks the problem down into smaller subproblems, which can then be solved based on the solutions to earlier subproblems.

Specifically, the keyframe engine recursively computes partial solutions, which are the lowest cost keyframes to represent frames 0 through M of the video, with a setting that frame M, the last frame of the partial solution, is to be a keyframe. The keyframe engine starts by solving for M=0, then M=1, and so on, until M is the last frame of the video. For each partial solution, the last frame is set to be a keyframe. However, this is not a requirement for the final solution.

To compute the partial solution for frame M, the keyframe engine considers the partial solutions for previous frames and selects the one with the lowest cost, plus the additional cost of representing the frames from the previous frame to frame M with either frame M or the previous frame. This process continues until the optimal solution for the entire video is found. It should be noted that a keyframe may represent frames that come either before or after the keyframe.

Additionally, the keyframe engine has a constraint that successive keyframes must be at most a threshold time (e.g., 20 seconds) or a threshold number of frames (e.g., 500 frames) apart. This helps to ensure that no long stretches (e.g., longer than the threshold time or the threshold number of frames) of the video are missed and also makes the computation more efficient, as the keyframe engine only needs to consider partial solutions from the last threshold time or the last threshold number of frames.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

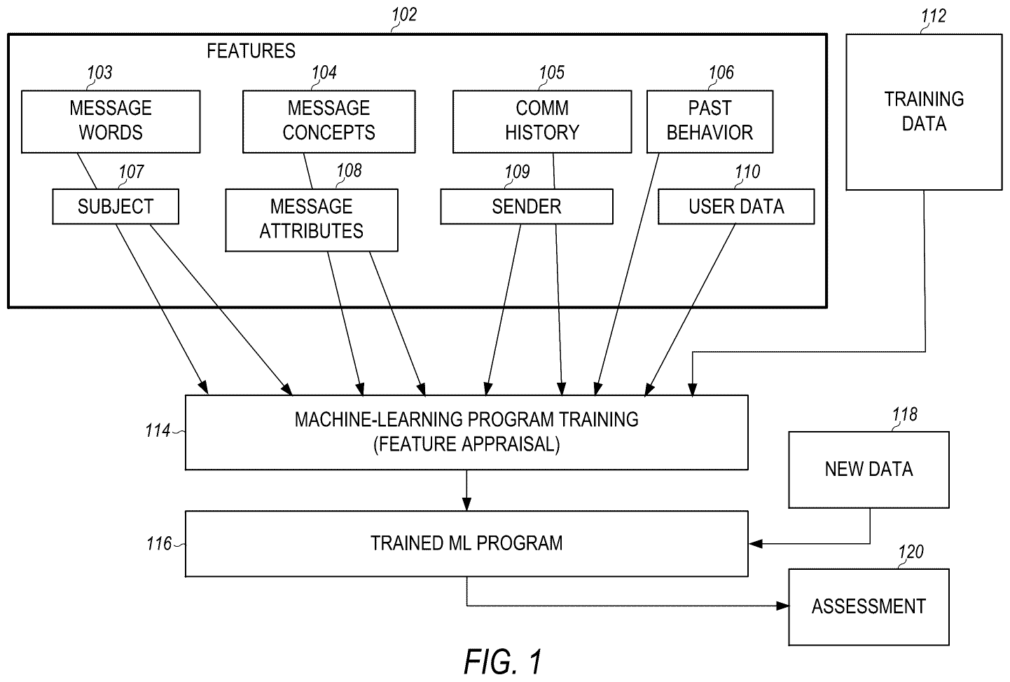

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in machine learning, a computer could be provided with examples of images of elephants and be trained to determine which images have and lack depictions of elephants, without the programmer encoding explicit instructions as to how to identify an elephant. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

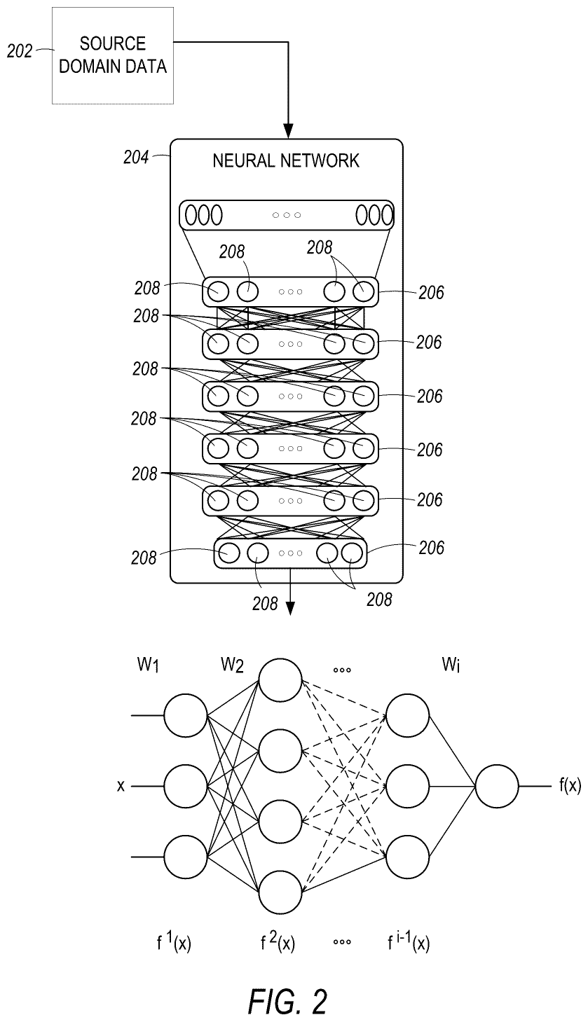

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . fⁱ⁻¹(x), until finally the output f (x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

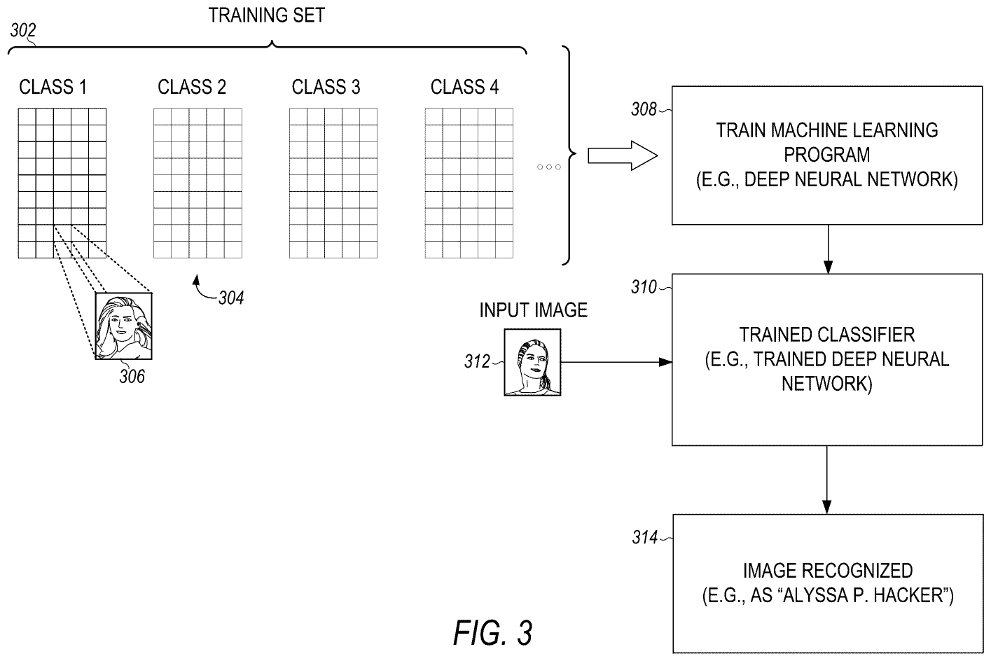

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of various persons (i.e., to map a photograph of a person to the person's name), and each class 304 corresponds to each person, with each individual class 304 corresponding to an individual person (e.g., one class corresponds to Alyssa P. Hacker, one class corresponds to Ben Bitdiddle, etc.). At block 308 the machine learning program is trained, for example, using a deep neural network. At block 310, the trained classifier (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

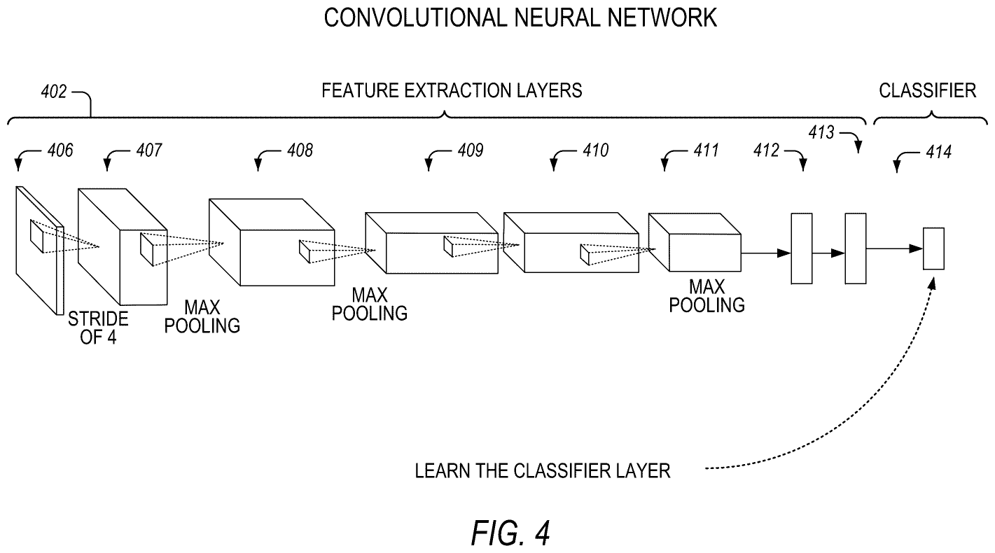

FIG. 4 illustrates a convolutional neural network, according to some example embodiments. Training a classifier of the convolutional neural network may be accomplished with feature extraction layers 402 and classifier layer 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

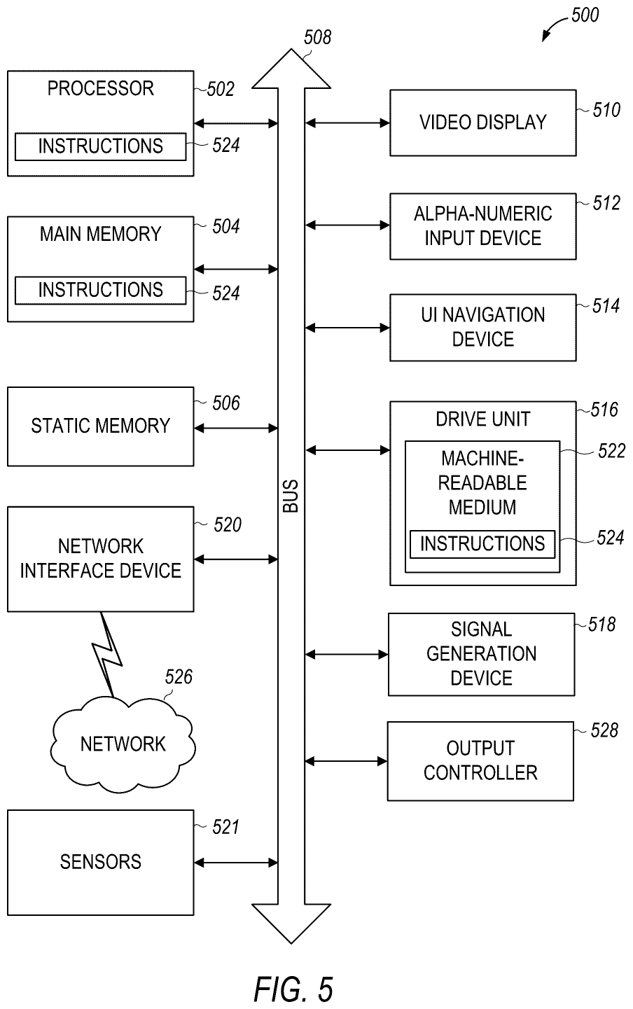

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

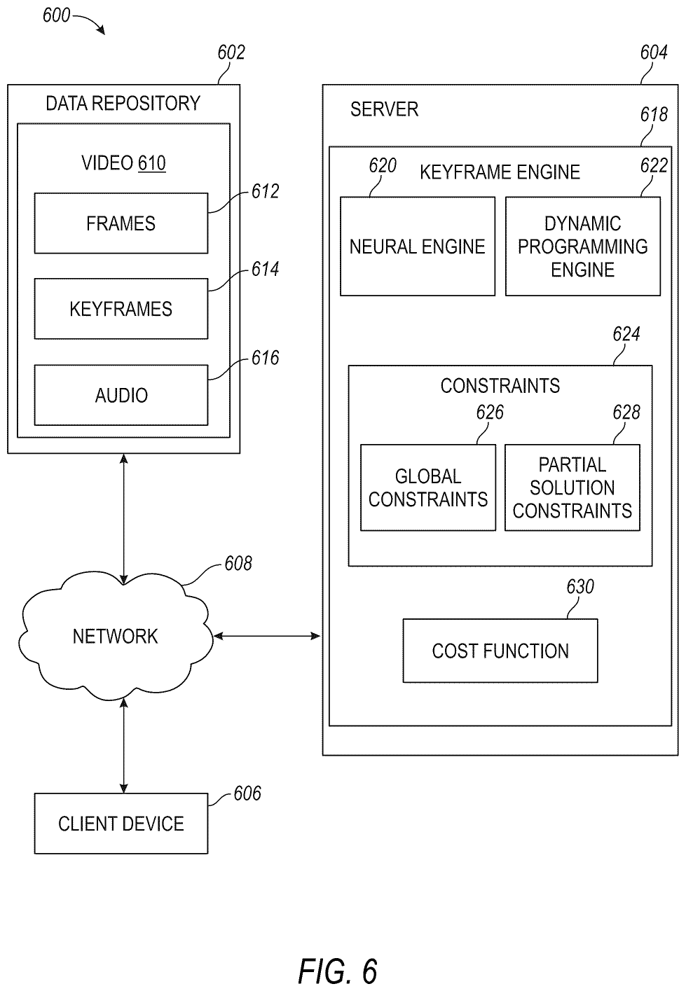

FIG. 6 is a block diagram of a system 600 for determining keyframes of a video, in accordance with some embodiments. As shown, the system 600 includes a data repository 602, a server 604, and a client device 606 connected to one another over a network 608. Each of the data repository 602, the server 604, or the client device 606 may correspond to the computing machine 500 or include a portion of the components of the computing machine 500. The data repository 602 may be a database or another data storage unit. As illustrated, the data repository 602 is independent of the server 604. However, in some cases, the data repository 602 may be a component of the server 604 or may be connected to the server 604 via a direct connection that is not the network 608. The data repository 602 is illustrated as a single machine, but may be a combination of multiple data repositories. The server 604 is illustrated as a single machine, but may be a server farm or a combination of multiple servers. The client device 606 may be, for example, a laptop computer, a desktop computer, a mobile phone, a tablet computer, a smart watch, a smart television, or the like. While a single client device 606 is illustrated, the system 600 may include multiple client devices. The network 608 may include one or more networks, for example, the Internet, an intranet, a local area network, a wide area network, a cellular network, a WiFi® network, or the like.

As shown, the data repository 602 stores a video 610. While a single video 610 is illustrated, the data repository 602 may include multiple videos. As shown, the video 610 includes frames 612, keyframes 614, and audio 616. The frames 612 is an ordered set of images in the video. The number of the frames 612 may be determined based on a time length of the video 610 (e.g., 310 seconds) and a frame rate of the video 610 (e.g., 24 frames per second). For example, the number of the frames 612 may correspond to a product of the time length and the frame rate.

The keyframes 614 are a subset of the frames 612 that are representative of the content of the video 610. For example, a user may view the keyframes 614 to quickly identify the content of the video and whether they wish to view the full video. Alternatively, software (e.g., artificial intelligence and/or image processing software) may use the keyframes 614 to determine what imagery is shown in the video 610. The keyframes 614 may be generated from the frames 612 using the techniques disclosed herein. The audio 616 includes audio (e.g., spoken language or other sounds) of the video 610. In some cases, the video 610 may lack audio. The video 610 may include only frames 612 of imagery.

As shown, the server 604 include a keyframe engine 618 for identifying the keyframes 614 based on the frames 612 of the video 610. The keyframe engine 618 includes a neural engine 620, a dynamic programming engine 622, constraints 624. The constraints 624 specify constraints for the keyframes 614 and include global constraints 626 and partial solution constraints 628. The global constraints 626 apply to the keyframes 614, while the partial solution constraints 628 apply to partial solutions that are generated during the process of determining the keyframes 614 as described below. The keyframe engine 618 also includes a cost function 630, which is to be optimized (e.g., minimized or maximizes) in identifying the keyframes 614 from among the frames 612.

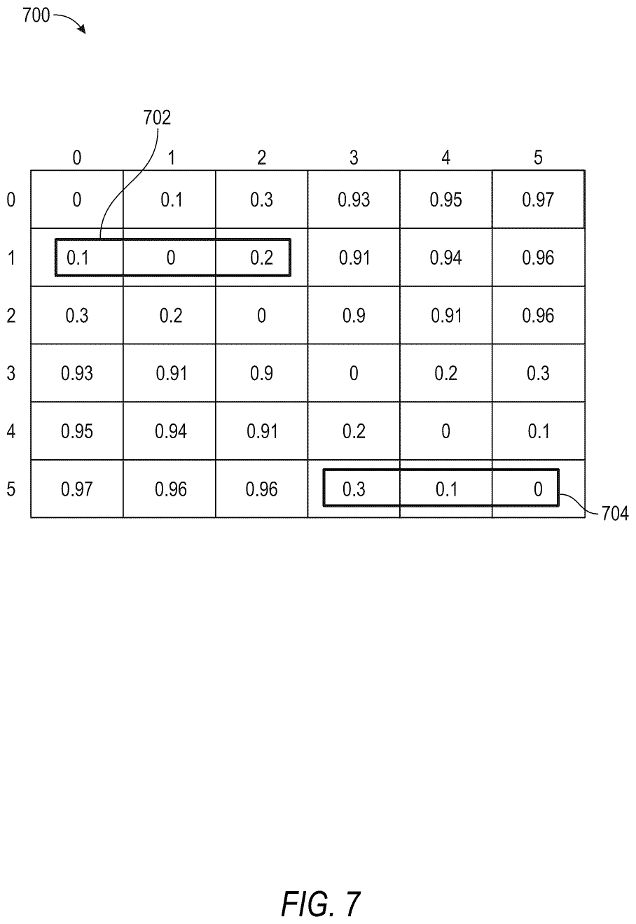

The neural engine 620 may include an artificial neural network (ANN), such as a convolutional neural network (CNN) and/or a deep neural network (DNN). The neural engine 620 computes the representation cost between pairs of the frames 612 in the video. The pairs of the frames 612 may correspond to each pair of the frames 612 or pairs of the frames 612 that are less than a threshold time (e.g., 30 seconds) or a threshold number of frames (e.g., 720 frames) apart. The threshold time or the threshold number of frames may be specified in the global constraints 626. The representation cost is a measure of how well one frame of the frames 612 represents another. For example, a representation cost of 0 may indicate that the frames in the pair are identical, and a representation cost of 1 may represent that the frames in the pair are very different. An example of representation costs for a small set of frames is illustrated in FIG. 7. In some cases, the neural engine 620 may include an ANN trained to determine how similar the two frames are to one another. In some cases, greater similarity (i.e., the two frames being more similar to one another) corresponds to a lower representation cost. The ANN may be trained using supervised learning.

Training the ANN using supervised learning to determine the representation cost between two images (e.g., two frames from among the frames 612) may involves several steps. First, a suitable dataset of image pairs and their corresponding representation costs is obtained. These representation costs can be obtained through human annotation, pre-existing algorithms, or a combination of both. The dataset is then divided into training, validation, and test sets.

The architecture of the ANN may be leveraged for capturing image features and their differences. CNNs may be used due to their ability to extract hierarchical features from images. The CNN processes each image separately, generating feature maps that encapsulate various levels of abstraction. These feature maps are then compared using a similarity metric, such as Euclidean distance or cosine similarity. The resulting similarity score is passed through a fully connected layer to produce the final representation cost. During training, the CNNs parameters are adjusted through backpropagation and gradient descent to minimize the difference between predicted and actual representation costs. The validation set is used to tune hyperparameters and avoid overfitting. Finally, the trained CNN is evaluated on the test set to assess its performance. In some cases, online learning may be used to further train the CNN based on the test set and/or real-world examples during the inference phase.

The trained neural engine 620 is used to generate a table with rows representing the frames 612, columns representing the frames 612, and cells representing representation costs. An example of the output of the neural engine 620 (along with other information) is illustrated in FIG. 7 and described in greater detail below.

After the table is generated by the neural engine 620, the dynamic programming engine 622 uses techniques based on dynamic programming to identify the keyframes 614 for the video 610. Dynamic programming may include, among other things, using a computer (e.g., the server 604) to break a problem (e.g., identifying the keyframes 614 from the frames 612) down into smaller subproblems. The computer then solves the full problem based on the solutions to earlier subproblems.

The table generated by the neural engine 620 is a N×N table, where N is the number of the frames 612 of the video 610. The frames may be numbered from 0 to N−1, where 0 represents the first frame in the time sequence of the frames 612 and N−1 represents the final frame in that time sequence.

The dynamic programming engine 622 begins by looking only at a sub-table that includes a single cell of the table at row 0, column 0. The dynamic programming engine 622 computes the lowest total cost keyframes for this sub-table that meets the constraints 624. The lowest total cost may be determined based on the cost function 630. (It should be noted that, in alternative implementations, the highest cost or another optimization of the cost, e.g., the closest cost to a preset value, may be used in place of the lowest cost.) This includes a single subframe associated with the frame 0. The dynamic programming engine 622 then considers the next sub-table that includes rows 0-1 and columns 0-1. The dynamic programming engine 622 computes the lowest total cost keyframes (based on the cost function 630) for this sub-table that meets the constraints 624. The dynamic programming engine 622 considers by considering the sub-table that includes rows/columns 0-2, 0-3, and so on. In other words, the dynamic programming engine 622 considers the sub-tables of rows/columns 0-M, sequentially for integer values of M from 0 to N−1. As described herein, the dynamic programming engine 622 uses recursive computation.

The cost function 630 may take into account the representation cost (e.g., from the table generated by the neural engine 620) of a selected keyframe with any frame (from the frames 612) the keyframe is to represent. The cost function 630 may also take into account the total number of keyframes for the table or sub-table. The cost function 630 may be a mathematical function of those representation costs and the total number of keyframes. In some examples, the cost function 630 is the sum of those representation costs and the total number of keyframes. In some cases, the cost function 630 is the product of the total number of keyframes and the sum of the representation costs. Alternatively, other mathematical functions may correspond to the cost function 630.

As illustrated, the constraints 624 include global constraints 626 and partial solution constraints 628. The global constraints 626 apply to all partial solutions (associated with the sub-tables) and the final solution associated with the full table. The partial solution constraints 628 apply to all partial solutions but not the final solution. In some cases, the global constraints 626 specify a maximum distance (in time (e.g., measured in seconds) or in number of frames in the ordered sequence of the frames 612) between two consecutive keyframes of the keyframes 614. This reduces the computation cost and ensures that no long (e.g., longer than the specified maximum distance) stretches of the video 610 lack keyframes. In some cases, the global constraints 626 specify that each keyframe of the keyframes 614 is to represent a time contiguous subset of the frames 612. This ensures that a keyframe is not chosen to represent a frame that is far (e.g., further than the specified maximum distance) from the keyframe. In some cases, the partial solution constraints 628 specify that frame M is a keyframe of the partial solutions. In some cases, the global constraints 626 and/or the partial solution constraints 628 may include additional constraints and/or different constraints from those specified herein.

After the partial solutions are generated, the final solution is generated based on at least a portion of the partial solutions. The final solution is adjusted to minimize (or otherwise optimize) the cost function 630 and to meet the global constraints 626 but not necessarily to meet the partial solution constraints 628. It should be noted that the partial solution for M=N−1, like all other partial solutions, meets the partial solution constraints 628.

After the final solution is generated, the keyframes identified in the final solution are stored as the keyframes 614 for the video 610 in the data repository 602. The keyframes 614 may be used by image processing technology to identify the visual content of the video 610. The keyframes 614 may be transmitted, via the network 608, to the client device 606 for display, for example, within a thumbnail representation of the video 610. The thumbnail representation may be presented, for example, via a display unit of the client device 606 on a webpage accessed using a web browser of the client device 606.

In some implementations, the dynamic programming engine 622 constructs a directed acyclic graph (DAG) to represent the possible keyframe selections and their associated costs. Each node in at least a part of the DAG represents a specific frame in the video, and directed edges between at least some of the nodes represent potential keyframe selections. The edge weights correspond to the representation costs computed by the neural engine 620.

The dynamic programming engine 622 iteratively populates this DAG starting from the first frame (frame 0) and proceeding through the frames in temporal order. For each new frame considered, the engine computes optimal keyframe selections based on previously computed solutions stored in the DAG. This approach allows the engine to reuse partial solutions, significantly reducing computational complexity compared to evaluating all possible keyframe combinations independently.

Specifically, for each frame M, the dynamic programming engine 622 adds nodes and edges to the DAG that represent selecting frame M as a keyframe to represent a range of preceding frames. The dynamic programming engine 622 considers some or all of the valid frame ranges based on the constraints 624, particularly the maximum distance between keyframes specified in the global constraints 626. The costs associated with these selections are stored in at least some of the edges of the DAG.

After the DAG is fully populated, the dynamic programming engine 622 applies a backtracking algorithm to traverse the graph from the final frame back to the beginning, identifying the path with the minimum total cost according to the cost function 630. This path corresponds to the optimal set of keyframes for the video 610. The backtracking algorithm systematically examines the decisions recorded during the forward pass through the graph, selecting the optimal choice at each step to construct the complete solution. As used herein, the term “backtracking algorithm” encompasses its plain and ordinary meaning in the field of computer science and algorithm design. A backtracking algorithm may include, among other things, a systematic approach for finding solutions to computational problems by incrementally building candidates for a solution and abandoning (or “backtracking” from) candidates that cannot satisfy the problem constraints or optimization criteria. In the context of the keyframe selection problem, the backtracking algorithm traverses the directed acyclic graph from end to start, reconstructing the optimal sequence of keyframes by selecting edges that correspond to the minimum total cost path.

For longer videos, the keyframe engine 618 may employ a temporal segmentation approach to improve efficiency. Instead of processing the entire video at once, the keyframe engine 618 divides the video 610 into multiple temporal segments. Each segment includes a manageable number of frames that can be efficiently processed by the dynamic programming engine 622.

For longer videos, the keyframe engine 618 may employ a temporal segmentation approach to improve efficiency. Instead of processing the entire video at once, the keyframe engine 618 divides the video 610 into multiple temporal segments. Each segment contains a manageable number of frames that can be efficiently processed by the dynamic programming engine 622. As used herein, the term “manageable number of frames” may refer to a quantity of frames that can be processed by the dynamic programming engine 622 within reasonable time and memory constraints based on available computing resources. For example, a manageable number of frames may range from several hundred to several thousand frames, depending on the complexity of the representation cost calculation, the specific implementation of the dynamic programming algorithm, and the hardware capabilities of the computing system executing the keyframe engine 618.

For example, in a real-world implementation on a server with 16 CPU cores, 64 GB of random-access memory (RAM), and a dedicated GPU with 8 GB of video random-access memory (VRAM), the keyframe engine 618 may process segments containing approximately 3,600 frames each, which corresponds to about 2 minutes of video content at 30 frames per second. Performance testing on this hardware configuration has shown that processing segments of this size allows the dynamic programming engine 622 to compute optimal keyframe sets within 2-3 seconds per segment, while larger segments of 7,200 frames (4 minutes of video) increased processing time to over 15 seconds per segment and required substantially more memory. For mobile or edge devices with more limited computational resources, the keyframe engine 618 may automatically adjust to smaller segment sizes of 900-1,800 frames to maintain reasonable processing times. This adaptive approach ensures that the keyframe selection process remains efficient across a wide range of deployment scenarios, from cloud-based video processing services to on-device applications.

The keyframe engine 618 computes local keyframe sets for each temporal segment independently using the same recursive subproblem decomposition approach described earlier. For each segment, the dynamic programming engine 622 identifies an optimal set of keyframes based on the representation costs within that segment and the constraints 624.

As used herein, the term “recursive subproblem decomposition” encompasses its plain and ordinary meaning in the field of algorithm design and optimization. Recursive subproblem decomposition refers to a problem-solving approach where a complex problem is broken down into smaller, simpler subproblems that share the same structure as the original problem but operate on a reduced data set. Solutions to these subproblems are then combined to form the solution to the original problem. In the context of keyframe selection, recursive subproblem decomposition involves computing optimal keyframe sets for progressively larger segments of frames by reusing solutions already computed for smaller segments, thereby avoiding redundant computations.

For instance, in a real-world implementation processing a news broadcast video archive, the keyframe engine 618 employed recursive subproblem decomposition to efficiently identify keyframes from 30-minute news segments containing approximately 54,000 frames (at 30 frames per second). By decomposing the keyframe selection problem, the system first computed optimal keyframe sets for 10-second intervals, then used these solutions to compute optimal sets for 1-minute intervals, and subsequently for the entire 30-minute segment. This approach reduced the processing time from an estimated 45 minutes (using a naive approach) to approximately 90 seconds, while maintaining the quality of the selected keyframes. The resulting keyframes successfully captured the transitions between news stories, interview segments, and visual demonstrations, providing an effective visual summary that enabled archivists to quickly catalog the content without watching the entire broadcasts.

After computing the local keyframe sets, the keyframe engine 618 employs a merging strategy to combine these local solutions into a coherent global set of keyframes for the entire video. The merging process ensures that the transition between segments is smooth and that the global constraints 626 are maintained across segment boundaries.

To ensure continuity and prevent missing important content at segment boundaries, the keyframe engine 618 may use overlapping temporal segments. In this approach, adjacent segments share a range of frames, allowing the engine to consider keyframe selections that span across what would otherwise be hard segment boundaries. For example, if each segment is 1000 frames long, the engine might define segments as frames 0-999, 800-1799, 1600-2599, and so on, with a 200-frame overlap between consecutive segments.

When merging solutions from the overlapping temporal segments, the keyframe engine 618 evaluates alternative keyframe selections in the overlap regions of the overlapping temporal segments and selects the combination that minimizes the overall cost function 630. This approach helps prevent suboptimal selections that might occur if segment boundaries were treated independently, particularly when important visual transitions occur near these boundaries.

FIG. 7 illustrates an example of representation costs and keyframes for a set of frames. The representation costs are represented in a table 700 with boxes 702, 704 representing keyframes and their associated frames.

The table 700 may be generated by the neural engine 620 of FIG. 6. The table 700 is for a short video (e.g., the video 610) including six frames (e.g., the frames 612) numbered 0 through 5. As is apparent from the table, the representation cost of each frame for itself is 0 because the frame is identical to itself (e.g., the representation cost of frame M to frame M is 0, where M is any integer between 0 and 5). The box 702 indicates that frame 1 is a keyframe that represents the frames 0-2. The box 704 indicates that frame 5 is a keyframe that represents frames 3-5. The keyframe 1 representing the frames 0-2 and the keyframe 5 representing frames 3-5 may have been selected based on the constraints 624 and the cost function 630. As illustrated, the table 700 is a symmetric table. However, in some implementations, the table 700 might not be symmetric. In other words, the cost of representing frame A with frame B may be different from the cost of representing frame B with frame A, where A and B are identifiers of frames (e.g., integers between 0 and 5 in the table 700).

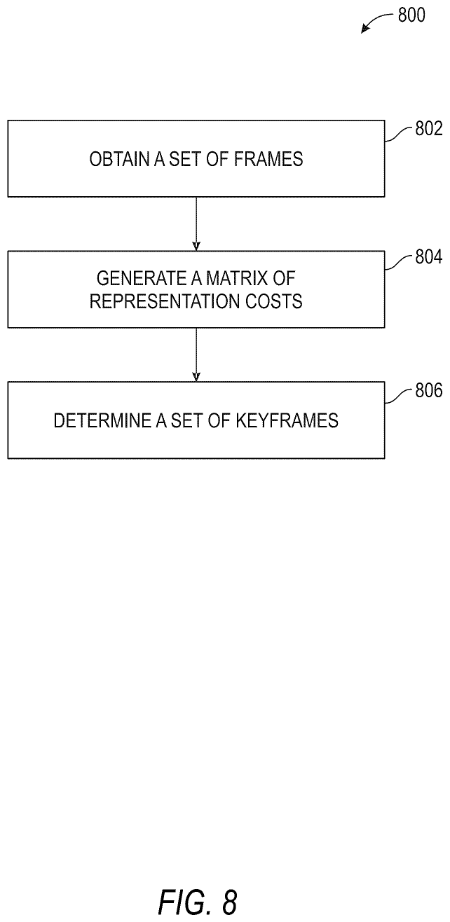

FIG. 8 is a flowchart of an example technique 800 for determining keyframes of a video, in accordance with some embodiments. The technique 800 may be performed by a computer, for example, the server 604. Alternatively, a computer different from the server 604 (e.g., a laptop computer or a desktop computer) may be used. While the computer is described as being a single machine, in some cases, the computer may include multiple machines working together.

At block 802, the computer obtains, from a data repository (e.g., the data repository 602), a set of frames (e.g., the frames 612) of a video (e.g., the video 610). The data repository may be an external data repository or a local memory of the computer.

At block 804, the computer generates a matrix (or another data structure in place of the matrix) of representation costs for the set of frames. The computer may use an ANN, such as a CNN or a DNN, to generate the matrix. Alternatively, other image processing techniques or statistical techniques may be used to generate the matrix. In some cases, the matrix has a first dimension representing the set of frames. The matrix has a second dimension representing the set of frames. The matrix has cell values representing a representation cost of representing a frame of the first dimension with a frame of the second dimension. This is illustrated, for example, in FIG. 7, and described in conjunction with FIG. 7.

At block 806, the computer determines a set of keyframes (e.g., the keyframes 614) for the video. The set of keyframes may be determined by a dynamic programming engine (e.g., the dynamic programming engine 622) and based on the matrix and stored rule(s) (e.g., the constraints 624). Each keyframe represents a time contiguous subset of the set of frames, for example, as described in conjunction with FIG. 7. The stored rule(s) may specify a maximum time period or a maximum number of frames between successive keyframes. In some cases, the computer determines the set of key frames by associating, by the dynamic programming engine, each frame of the set of frames with a keyframe based on minimizing a mathematical function (e.g., the cost function 630) of a number of keyframes and a representation cost of a frame and an associated keyframe of the frame. The mathematical function may be a summation.

In some cases, to determine the set of keyframes for the matrix, the computer determines a set of keyframes for a portion of the matrix. The computer determines the set of keyframes for the matrix based on the set of keyframes for the portion.

In some cases, to determine the set of keyframes for the matrix, the computer recursively determines sets of keyframes for portions of the matrix. The computer determines the set of keyframes for the matrix based on the sets of keyframes for the portions.

The computer provides an output of the set of keyframes. In some cases, the output is transmitted to the data repository for storage therein. In some cases, the output is stored in the local memory of the computer. In some cases, the output is displayed at the computer or transmitted to a client device (e.g., the client device 606), different from the computer, for display thereat.

According to some examples, to provide the output, the computer generates a second video including the set of keyframes. The computer transmits the second video for display at the client device.

According to some examples, to provide the output, the computer transmits, to the client device via a network (e.g., the network 608), a single frame of the set of keyframes (e.g., the first in time keyframe) for display at the client device. The computer receives, from the client device via the network, a signal representing hovering a cursor over the single frame. The computer causes, based on the signal, a sequential display, at the client device, of keyframes from the set of keyframes. In some case, the hovering cursor may overlay a part of the keyframes while the sequential display is ongoing. The sequential display may stop if the user moves the cursor off the display of the keyframes.

Some examples are described with the representation costs being stored in a matrix (e.g., the table 700). However, it should be noted that another data structure may be used in place of the matrix. For example, the data structure may be at least one of a sparse matrix, a hash table, a directed acyclic graph, a hierarchical tree structure, a priority queue, a multi-dimensional array, a tensor, a linked list, a dictionary data structure, or any combination thereof. The specific data structure may be selected based on considerations such as memory efficiency, computational complexity, or the size of the set of frames being processed. For larger videos with many frames, memory-efficient data structures such as sparse matrices may be used, as some representation costs between distant frames may not need to be computed or stored.

Some embodiments are described as numbered examples (Example 1, 2, 3, etc.). These are provided as examples only and do not limit the technology disclosed herein.

Example 1 is a method for determining video keyframes, the method comprising: obtaining, from a data repository, a set of frames of a video; generating, by a neural engine, a data structure of representation costs for the set of frames; determining, by a dynamic programming engine and based on the data structure and at least one stored rule, a set of keyframes for the video, wherein each keyframe represents a time contiguous subset of the set of frames; and providing an output of the set of keyframes.

In Example 2, the subject matter of Example 1 includes, wherein the at least one stored rule specifies a maximum time period or a maximum number of frames between successive keyframes.

In Example 3, the subject matter of Examples 1-2 includes, wherein determining the set of keyframes comprises: determining a set of keyframes for a portion of the data structure; and determining the set of keyframes for the data structure based on the set of keyframes for the portion.

In Example 4, the subject matter of Examples 1-3 includes, wherein the data structure comprises a matrix, wherein determining the set of keyframes comprises: recursively determining sets of keyframes for portions of the matrix; and determining the set of keyframes for the matrix based on the sets of keyframes for the portions.

In Example 5, the subject matter of Examples 1-4 includes, wherein determining the set of keyframes comprises: associating, by the dynamic programming engine, each frame of the set of frames with a keyframe based on minimizing a mathematical function of a number of keyframes and a representation cost of a frame and an associated keyframe of the frame.

In Example 6, the subject matter of Example 5 includes, wherein the mathematical function comprises a summation.

In Example 7, the subject matter of Examples 1-6 includes, wherein the data structure comprises a matrix, wherein the matrix comprises a first dimension representing the set of frames, a second dimension representing the set of frames, and cell values representing a representation cost of representing a frame of the first dimension with a frame of the second dimension.

In Example 8, the subject matter of Examples 1-7 includes, wherein providing the output of the set of keyframes comprises: generating a second video comprising the set of keyframes; and transmitting the second video for display at a client device.

In Example 9, the subject matter of Examples 1-8 includes, wherein providing the output of the set of keyframes comprises: transmitting, to a client device via a network, a single frame of the set of keyframes for display at the client device; receiving, from the client device via the network, a signal representing hovering a cursor over the single frame; and causing, based on the signal, a sequential display, at the client device, of keyframes from the set of keyframes.

In Example 10, the subject matter of Examples 1-9 includes, wherein determining the set of keyframes comprises: constructing, by the dynamic programming engine, a directed acyclic graph for representing keyframe selections; iteratively populating, by the dynamic programming engine, the directed acyclic graph by computing the keyframe selections for progressively larger subsets of frames based on previously computed solutions stored in the directed acyclic graph; and applying a backtracking algorithm to the directed acyclic graph to identify the set of keyframes.

In Example 11, the subject matter of Examples 1-10 includes, wherein determining the set of keyframes comprises: dividing the video into temporal segments; computing local keyframe sets for at least one of the temporal segments using recursive subproblem decomposition; and merging the local keyframe sets to determine the set of keyframes.

In Example 12, the subject matter of Example 11 includes, wherein the temporal segments comprise at least two overlapping temporal segments.

Example 13 is a non-transitory computer-readable medium storing instructions operable to cause one or more processors to perform operations comprising: obtaining, from a data repository, a set of frames of a video; generating, by a neural engine, a data structure of representation costs for the set of frames; determining, by a dynamic programming engine and based on the data structure and at least one stored rule, a set of keyframes for the video, wherein each keyframe represents a time contiguous subset of the set of frames; and providing an output of the set of keyframes.

In Example 14, the subject matter of Example 13 includes, wherein the at least one stored rule specifies a maximum time period or a maximum number of frames between successive keyframes.

In Example 15, the subject matter of Examples 13-14 includes, wherein determining the set of keyframes comprises: determining a set of keyframes for a portion of the data structure; and determining the set of keyframes for the data structure based on the set of keyframes for the portion.

In Example 16, the subject matter of Examples 13-15 includes, wherein the data structure comprises a matrix, wherein determining the set of keyframes comprises: recursively determining sets of keyframes for portions of the matrix; and determining the set of keyframes for the matrix based on the sets of keyframes for the portions.

Example 17 is a system, comprising: a memory subsystem storing instructions; and processing circuitry configured to execute the instructions to perform operations comprising: obtaining, from a data repository, a set of frames of a video; generating, by a neural engine, a data structure of representation costs for the set of frames; determining, by a dynamic programming engine and based on the data structure and at least one stored rule, a set of keyframes for the video, wherein each keyframe represents a time contiguous subset of the set of frames; and providing an output of the set of keyframes.

In Example 18, the subject matter of Example 17 includes, wherein determining the set of keyframes comprises: associating, by the dynamic programming engine, each frame of the set of frames with a keyframe based on minimizing a mathematical function of a number of keyframes and a representation cost of a frame and an associated keyframe of the frame.

In Example 19, the subject matter of Examples 17-18 includes, wherein the data structure comprises a matrix, wherein the matrix comprises a first dimension representing the set of frames, a second dimension representing the set of frames, and cell values representing a representation cost of representing a frame of the first dimension with a frame of the second dimension.

In Example 20, the subject matter of Examples 17-19 includes, wherein providing the output of the set of keyframes comprises: generating a second video comprising the set of keyframes; and transmitting the second video for display at a client device.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to an intersection or a union of sets of data. For example, the phrase “A and/or B” encompasses the union of A and B. The phrase “A and/or B” encompasses the intersection of A and B.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for determining video keyframes, the method comprising:
obtaining, from a data repository, a set of frames of a video;
generating, by a neural engine, a data structure of representation costs for the set of frames;
determining, by a dynamic programming engine and based on the data structure and at least one stored rule, a set of keyframes for the video, wherein each keyframe represents a time contiguous subset of the set of frames; and
providing an output of the set of keyframes.

2. The method of claim 1, wherein the at least one stored rule specifies a maximum time period or a maximum number of frames between successive keyframes.

3. The method of claim 1, wherein determining the set of keyframes comprises:
determining a set of keyframes for a portion of the data structure; and
determining the set of keyframes for the data structure based on the set of keyframes for the portion.

4. The method of claim 1, wherein the data structure comprises a matrix, wherein determining the set of keyframes comprises:
recursively determining sets of keyframes for portions of the matrix; and
determining the set of keyframes for the matrix based on the sets of keyframes for the portions.

5. The method of claim 1, wherein determining the set of keyframes comprises:
associating, by the dynamic programming engine, each frame of the set of frames with a keyframe based on minimizing a mathematical function of a number of keyframes and a representation cost of a frame and an associated keyframe of the frame.

6. The method of claim 5, wherein the mathematical function comprises a summation.

7. The method of claim 1, wherein the data structure comprises a matrix, wherein the matrix comprises a first dimension representing the set of frames, a second dimension representing the set of frames, and cell values representing a representation cost of representing a frame of the first dimension with a frame of the second dimension.

8. The method of claim 1, wherein providing the output of the set of keyframes comprises:
generating a second video comprising the set of keyframes; and
transmitting the second video for display at a client device.

9. The method of claim 1, wherein providing the output of the set of keyframes comprises:
transmitting, to a client device via a network, a single frame of the set of keyframes for display at the client device;
receiving, from the client device via the network, a signal representing hovering a cursor over the single frame; and
causing, based on the signal, a sequential display, at the client device, of keyframes from the set of keyframes.

10. The method of claim 1, wherein determining the set of keyframes comprises:
constructing, by the dynamic programming engine, a directed acyclic graph for representing keyframe selections;
iteratively populating, by the dynamic programming engine, the directed acyclic graph by computing the keyframe selections for progressively larger subsets of frames based on previously computed solutions stored in the directed acyclic graph; and
applying a backtracking algorithm to the directed acyclic graph to identify the set of keyframes.

11. The method of claim 1, wherein determining the set of keyframes comprises:
dividing the video into temporal segments;
computing local keyframe sets for at least one of the temporal segments using recursive subproblem decomposition; and
merging the local keyframe sets to determine the set of keyframes.

12. The method of claim 11, wherein the temporal segments comprise at least two overlapping temporal segments.

13. A non-transitory computer-readable medium storing instructions operable to cause one or more processors to perform operations comprising:
obtaining, from a data repository, a set of frames of a video;
generating, by a neural engine, a data structure of representation costs for the set of frames;
determining, by a dynamic programming engine and based on the data structure and at least one stored rule, a set of keyframes for the video, wherein each keyframe represents a time contiguous subset of the set of frames; and
providing an output of the set of keyframes.

14. The non-transitory computer-readable medium of claim 13, wherein the at least one stored rule specifies a maximum time period or a maximum number of frames between successive keyframes.

15. The non-transitory computer-readable medium of claim 13, wherein determining the set of keyframes comprises:
determining a set of keyframes for a portion of the data structure; and
determining the set of keyframes for the data structure based on the set of keyframes for the portion.

16. The non-transitory computer-readable medium of claim 13, wherein the data structure comprises a matrix, wherein determining the set of keyframes comprises:
recursively determining sets of keyframes for portions of the matrix; and
determining the set of keyframes for the matrix based on the sets of keyframes for the portions.

17. A system, comprising:
a memory subsystem storing instructions; and
processing circuitry configured to execute the instructions to perform operations comprising:
obtaining, from a data repository, a set of frames of a video;
generating, by a neural engine, a data structure of representation costs for the set of frames;
determining, by a dynamic programming engine and based on the data structure and at least one stored rule, a set of keyframes for the video, wherein each keyframe represents a time contiguous subset of the set of frames; and
providing an output of the set of keyframes.

18. The system of claim 17, wherein determining the set of keyframes comprises:
associating, by the dynamic programming engine, each frame of the set of frames with a keyframe based on minimizing a mathematical function of a number of keyframes and a representation cost of a frame and an associated keyframe of the frame.

19. The system of claim 17, wherein the data structure comprises a matrix, wherein the matrix comprises a first dimension representing the set of frames, a second dimension representing the set of frames, and cell values representing a representation cost of representing a frame of the first dimension with a frame of the second dimension.

20. The system of claim 17, wherein providing the output of the set of keyframes comprises:
generating a second video comprising the set of keyframes; and
transmitting the second video for display at a client device.
